(19) United States
(12) Patent Application Publication
(10) Pub. No.: US 2017/0331914 A1
(43) Pub. Date: Nov. 16, 2017

(54) SYSTEM AND METHOD FOR OPTIMIZING ONLINE VIDEO STREAMING TO A USER

(71) Applicant: ATERLO NETWORKS INC., Waterloo (CA)

(72) Inventor: Scot G. Loach, Waterloo (CA)

(73) Assignee: Aterlo Networks Inc.

(21) Appl. No.: 15/155,847

(22) Filed: May 16, 2016

(51) Int. Cl. H04L 29/08; H04L 29/06

(52) U.S. Cl. CPC H04L 67/2847; H04L 65/60; H04L 65/80

(57) ABSTRACT

A system, method and computer program product for providing multimedia content. A content caching system communicates with client devices over a local network. The content caching system determines device playback characteristics for each client device. Location-specific multimedia representation types and content indicators are determined for the client devices. Content representations to pre-position are determined from the location-specific multimedia representation types and content indicators. The pre-position content representations are stored in the content caching system where they are available for playback by the client devices over the local network.

### FIELD

The described embodiments relate generally to multimedia content. Specifically, the described embodiments relate to systems and methods for providing online multimedia content.

### BACKGROUND

The consumption of media content has changed over time. Increasingly, multimedia content is delivered to consumers by on-demand platforms. Consumers want to choose what they watch, as well as how and when they watch. Many different systems and platforms are now available for on-demand content delivery. These platforms range from on-demand cable options and personal video recorders, to online streaming services and devices such as Netflix®, Amazon Prime, Roku® and Apple TV.

Consumers also want high quality content. As the audio and visual quality of content improves, the amount of data that needs to be transferred to deliver the content increases. Higher data transfer rates are required to provide this high-quality content on demand. This places an increased burden on the communications networks tasked to transfer the content data.

Adaptive video playback techniques have been developed to balance some of these competing factors. Adaptive video playback tends to start by providing low bitrate video encodings to initiate the content quickly. The video playback then scales up to higher bitrate encodings if the network can support higher bitrates.

### SUMMARY

In some aspects, embodiments described herein provide a method for providing multimedia content to at least one client device. The method can include providing a content caching system operable to communicate with the at least one client device over a local network; determining device playback characteristics for each client device of the at least one client device using the content caching system, the device playback characteristics for a particular client device defining multimedia representation types playable using that particular client device; determining a plurality of location-specific multimedia representation types for the at least one client device using the content caching system, each location-specific multimedia representation type suitable for playback on a particular client device of the at least one client device; determining location-specific content indicators for the at least one client device using the content caching, system; identifying a plurality of multimedia content instances based on the location-specific content indicators using the content caching system; identifying a plurality of pre-position content representations to store in the content caching system prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and storing at least some of the pre-position content representations in the content caching system, where each pre-position content representation stored in the content caching system is available for playback by the at least one client device using the local network.

In some examples, determining the device playback characteristics for each client device may include: identifying at least one multimedia player available for multimedia playback on that client device, for each multimedia player, determining at least one player-specific set of playback characteristics, each player-specific set of playback characteristics defining multimedia representation types playable using that multimedia player; and determining the device playback characteristics for that client device to include the at least one player-specific set of playback characteristics for each multimedia player.

In some examples, the storing of at least some of the pre-position content representations in the content caching system may include determining a prioritized list of pre-position content representations from the plurality of pre-position content representations; and storing the at least some of the pre-position content representations from the plurality of pre-position content representations in priority order using the prioritized list of pre-position content representations.

In some examples, determining the prioritized list of pre-position content representations may include monitoring, using the content caching system, historic representation type data, the historic representation type data defining at least one multimedia representation type previously played back using the at least one client device; determining preferred content representation types based on the monitored historic representation type data, each preferred content representation type corresponding to one of the location-specific multimedia representation types; identifying preferred content representations as pre-position content representations in the plurality of pre-position content representations corresponding to one of the preferred content representation types; and determining the prioritized list using the preferred content representations.

In some examples, the method may further include identifying a location-specific content threshold of the content caching system, the location-specific content threshold defining a minimum amount of content to be pre-positioned; determining an available storage capacity in the content caching system; determining a stored content level defining an amount of pre-position content representations currently stored in the content caching system; and the determining the prioritized list of pre-position content representations is based on the location-specific content threshold, the stored content level and the available storage capacity.

In some examples, the method may further include determining a pre-positioning window using data policy data for the content caching system, the data policy data defining limits on data transfer between the content caching system and the external network; and the storing of the at least some of the pre-position content representations may occur during the pre-positioning window.

In some examples, the method may further include determining a window allowance for the pre-position window using historic bitrate data for the content caching system, the historic bitrate data defining a historically achieved download bitrate between the content caching system and an external network, and limiting the storage of the at least some of the pre-position content representations during the pre-positioning window based on the determined window allowance.

In some examples, determining the location-specific content indicators may include monitoring, using the content caching system, historic content type data, the historic content type data defining at least content type previously played using the at least one client device: determining preferred content types from the monitored historic content type data; and determining the location-specific content indicators using the preferred content types.

In some examples, determining the location-specific content indicators may also include monitoring user-indicated content indicators received by the content caching system.

In some examples, determining the location-specific content indicators may also include monitoring content playback selections received by the content caching system.

In some examples, the method may further include identifying by the content caching system a multimedia request from a particular client device of the at least one client device, the multimedia request defining a particular multimedia content instance to be played at the particular client device; identifying a particular pre-position content representation stored in the content caching system that is a representation of the particular multimedia content instance requested; and providing the particular pre-position content representation to the particular client device for playing the particular multimedia content instance.

In some examples, the multimedia request identifies a requested multimedia representation type; and the multimedia representation type corresponding to the particular pre-position content representation is different from the requested multimedia representation type.

In some examples, the multimedia request defines a request for available multimedia representation types for the particular multimedia content instance. In some such examples, the method may further include intercepting by the content caching system an availability manifest being transmitted to the particular client device, the availability manifest identifying at least one initial available multimedia representation type; modifying by the content caching system the availability manifest by at least one of removing one of the initial available multimedia representation types and adding an additional available multimedia representation types; and transmitting the modified availability manifest to the particular client device.

In some aspects, embodiments described herein provide an apparatus for providing multimedia content to at least one client device. The apparatus may include a content caching system, the content caching system communicatively coupled to the at least one client device over a local network and to at least one content delivery server over a wide network. The content caching system may include a content storage database and a content storage controller having a processor and a memory. The content storage controller can be configured to determine device playback characteristics for each client device of the at least one client device, the device playback characteristics for a particular client device defining multimedia representation types playable using that particular client device; determine a plurality of location-specific multimedia representation types for the at least one client device, each location-specific multimedia representation type suitable for playback on a particular client device of the at least one client device; determine location-specific content indicators for the at least one client device; identify a plurality of multimedia content instances from the location-specific content indicators; identify a plurality of pre-position content representations to store in the content storage database prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and store at least some of the pre-position content representations in the content storage database; and the content storage database stores the at least some of the pre-position content representations so that the at least some of the pre-position content representations are available for playback by the at least one client device using the local network.

In some examples, the content storage controller can be further configured to, for each client device, determine the device playback characteristics by identifying at least one multimedia player available for multimedia playback on that client device; for each multimedia player, determining at least one player-specific set of playback characteristics, each player-specific set of playback characteristics defining multimedia representation types playable using that multimedia player; and determining the device playback characteristics for that client device to include the at least one player-specific set of playback characteristics for each multimedia player.

In some examples, the content storage controller can be further configured to store the at least some of the pre-position content representations in the content storage database by determining a prioritized list of pre-position content representations to store from the plurality of pre-position content representations; and storing the at least some of the pre-position content representations from the plurality of pre-position content representations in priority order using the prioritized list of pre-position content representations.

In some examples, the content storage controller can be configured to determine the prioritized list of pre-position content representations by monitoring historic representation type data defining at least one multimedia representation type previously played back using the at least one client device; determining preferred content representation types based on the monitored historic representation type data, each preferred content representation type corresponding to one of the location-specific multimedia representation types; identifying preferred content representations as pre-position content representations in the plurality of pre-position content representations corresponding to one of the preferred content representation types; and determining the prioritized list using the preferred content representations.

In some examples, the content storage controller can be further configured to identify a location-specific content threshold, the location-specific content threshold defining a minimum amount of content to be stored in the content storage database; determine an available storage capacity in the content storage database; determine a stored content level defining an amount of pre-position content representations currently stored in the content storage database; and determine the prioritized list of pre-position content representations based on the location-specific content threshold, the stored content level and the available storage capacity.

In some examples, the content storage controller can be further configured to determine a pre-positioning window using data policy data, the data policy data defining limits on downloads to the content caching system over the wide network; and storing the at least some of the pre-position content representations in the content storage database during the pre-positioning window.

In some examples, the content storage controller can be further configured to determine a window allowance for the pre-position window using historic bitrate data for the content caching system, the historic bitrate data defining a historically achieved download bitrate between the content caching system and the at least one content delivery server over the wide network, and limit the storage of the at least some of the pre-position content representations during the pre-positioning window based on the determined window allowance.

In some examples, the content storage controller can be configured to determine the location-specific content indicators by monitoring historic content type data defining at least content type previously played using the at least one client device; determining preferred content types from the monitored historic content type data; and determining the location-specific content indicators using the preferred content types.

In some examples, the content storage controller can be configured to determine the location-specific content indicators by monitoring received indications of user content preferences.

In some examples, the content storage controller can be configured to determine the location-specific content indicators by monitoring received content playback selections.

In some examples, the content storage controller can be further configured to identify a multimedia request from a particular client device of the at least one client device, the multimedia request defining a particular multimedia content instance to be played at the particular client device; identify a particular pre-position content representation stored in the content storage database that is a representation of the particular multimedia content instance requested; and provide the particular pre-position content representation from the content storage database to the particular client device for playing the particular multimedia content instance.

In some examples, the multimedia request identifies a requested multimedia representation type; and the multimedia representation type corresponding to the particular pre-position content representation is different from the requested multimedia representation type.

In some examples, the multimedia request defines a request for available multimedia representation types for the particular multimedia content instance; and the content storage controller can be configured to intercept an availability manifest being transmitted to the particular client device, the availability manifest identifying at least one initial available multimedia representation type; modify the availability manifest by at least one of removing one of the initial available multimedia representation types and adding an additional available multimedia representation types; and transmit the modified availability manifest to the particular client device

In some aspects, embodiments described herein provide a non-transitory, computer-readable storage medium storing instructions executable by a processor coupled to the storage medium, the instructions for programming the processor to communicate with at least one client device over a local network and to at least one content delivery server over a wide network; determine device playback characteristics for each client device of the at least one client device, the device playback characteristics for a particular client device defining multimedia representation types playable using that particular client device; determine a plurality of location-specific multimedia representation types for the at least one client device, each location-specific multimedia representation type suitable for playback on a particular client device of the at least one client device; determine location-specific content indicators for the at least one client device; identify a plurality of multimedia content instances from the location-specific content indicators: identify a plurality of pre-position content representations to store in a content storage database prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and store at least some of the pre-position content representations in the content storage database so that the at least some of the pre-position content representations are available for playback by the at least one client device using the local network.

### BRIEF DESCRIPTION OF THE DRAWINGS

Various embodiments of the present application will now be described in detail with reference to the drawings, in which:

FIG. 1 shows a block diagram of a content delivery system;

FIG. 2 shows a block diagram of a system for providing multimedia content in accordance with an example embodiment;

FIG. 3 shows a block diagram of an apparatus for providing multimedia content that can be implemented with the system of FIG. 2 in accordance with an example embodiment;

FIG. 4 shows a flowchart of a process for providing multimedia content that may be implemented using the system of FIG. 2 and/or the apparatus of FIG. 3 in accordance with an example embodiment;

FIG. 5 shows a flowchart of a process for providing multimedia content that may be implemented using the system of FIG. 2 and/or the apparatus of FIG. 3 in accordance with an example embodiment;

FIG. 6 shows a flowchart of a process for providing multimedia content that may be implemented using the system of FIG. 2 and/or the apparatus of FIG. 3 in accordance with an example embodiment;

FIG. 7 shows a flowchart of a sub-process for delivering multimedia content that may be implemented using the system of FIG. 2 and/or the apparatus of FIG. 3 in accordance with an example embodiment;

FIG. 8 shows a flowchart of a process for pre-positioning multimedia content that may be implemented using the system of FIG. 2 and/or the apparatus of FIG. 3 in accordance with an example embodiment;

FIG. 9 shows a flowchart of a process for delivering multimedia content that may be implemented using the system of FIG. 2 and/or the apparatus of FIG. 3 in accordance with an example embodiment.

The drawings are provided for the purposes of illustrating various aspects and features of the example embodiments described herein. For simplicity and clarity of illustration, elements shown in the figures have not necessarily been drawn to scale. Further, where considered appropriate, reference numerals may be repeated among the figures to indicate corresponding or analogous elements

### DESCRIPTION OF EXEMPLARY EMBODIMENTS

Various systems or methods will be described below to provide an example of an embodiment of the claimed subject matter. No embodiment described below limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described below is not an embodiment that is recited in any claimed subject matter. Any subject matter disclosed in a system or method described below that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal or a mechanical element depending on the particular context. Furthermore, the term “communicative coupling” may be used to indicate that an element or device can electrically, optically, or wirelessly send data to another element or device as well as receive data from another element or device,

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about” and “approximately” as used herein mean a reasonable amount of deviation of the modified term such that the end result its not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are example embodiments of systems, methods, and computer program products for providing multimedia content to at least one client device. The multimedia content may be provided to a client device in response to a request to stream online video content. The at least one client device may be associated with a particular location. The embodiments described herein can be configured to provide multimedia content for a plurality of devices associated with a particular consumer or location.

Various types of playback devices and mediums are available to consumers. The devices can be designed to work with various different formats and encodings of multimedia content. As a result, different formatting and encoding techniques are often used to format and encode the same piece of content. These different formatting and encoding techniques may be generally referred to herein as representation types, being different types or ways of representing content in data. Individual pieces of content that may be consumed by a user, such as a movie or a TV show, will generally be referred to herein as content instances. In general, each content instance includes a watchable video element and may also include audio elements as well. Content instances having certain content characteristics in common may be referred to as a content type, such as a genre or style of content (e.g, drama, action, romance etc.)

The embodiments described herein may identify particular content instances, as well as particular representation types that may be expected to be requested by a consumer and/or are suitable for playback using the consumer's devices. These identified content instances and representations types can be used to determine specific content representations to provide to the consumer/location. As used herein, the term content representation generally refers to a combination of a particular content instance and a particular representation type, for instance a specific movie in a specific format/encoding and having a specific resolution.

In general, multimedia content such as videos can be streamed from a content server to a consumer player, over a wide area network such as the internet. A consumer selects a content instance they want to watch, and uses a device and player to display the content instance. As used herein, the client device refers to a hardware or combined hardware and software object used that receives and displays the content such as a smartphone, a tablet, a general purpose computer such as a laptop or desktop computer, a smart TV or combination of a TV and devices such as an Apple TV device, a Roku® device or a gaming system etc. In some cases, the client device may include multiple devices such as a gaming system that is coupled to a display. As used herein, the term player generally refers to the software application used to process and play the content, such as a web browser, an application, a media player such as iTunes, VLC or Windows Media Player etc.

A content instance is typically stored on a content server. Each content instance may be stored as one or more content files that are encoded using one or more container formats such as MP4. Each content file may contain an entire content instance, a portion of a content instance, or may even contain a plurality of content instances. Often, there may be a plurality of content representations for a particular content instance on the server, corresponding to a plurality of representation types. Each representation type may be configured to support different players and/or different devices and/or different network capabilities.

For example, a particular content instance may be configured with one or more representation types that account for players that use HTTP Live Streaming (HLS) for content delivery as well as one or more representations types that use Dynamic Adaptive Streaming over HTTP (DASH). The content instance may also be represented in representation types having different bitrate levels, e.g. to account for different network capabilities. For instance, a particular content instance may be represented in different representation types configured to support bitrates ranging from a 2G wireless network up to a fiber connection. Representation types having different bitrate levels may also account for differences in screen resolution of the devices used for content playback. For instance, a handheld phone may use a low definition resolution such as 320×240, while a home television may use a 4 K UHD resolution of 3840×2160. Accordingly, a particular content server may have a significant number of different content representations corresponding to a particular content instance and the various representation types for that content instance.

In some embodiments, adaptive bitrate streaming techniques may be used to provide content representations. Adaptive bitrate streaming may be used to dynamically select which bitrate of a video to download. This selection can be based on the capabilities of the device and/or real-time feedback from the network as video is downloaded and played. Some examples of adaptive streaming, techniques include HLS, HTTP Dynamic Streaming (HDS), DASH and Smooth Streaming.

In some embodiments, a player may first request a manifest file from a content server. A manifest file includes content representation data defining the representation types (e.g. different bitrates) available for a particular content instance. The player may then request at least, one content portion of a particular content representation using the content representation data from the manifest file. The content portions can be downloaded to an in-memory buffer within the player, and each content portion can be decoded and displayed to the consumer. Often, the player may attempt to keep one or more content portions in the buffer so that temporary network congestion will not cause the player to stall. For example, a player may keep content portions corresponding to a period of time, such as 5 minutes of video, in the buffer.

In adaptive streaming techniques, the player starts with low-bitrate content portions. If the player determines that the buffer can be filled with content portions faster than the content is being consumed from the buffer, the player may then begin downloading a higher bitrate content representation into the buffer so that the consumer will see better quality video. This cycle may continue until the player has either reached the highest bitrate video in the manifest, or until the network will not deliver content at a high enough speed to keep the buffer full. As the content plays, the bitrate of video being downloaded may be adjusted up and down dynamically based on real-time measurement of whether the network can keep the buffer full. This may provide an improved viewing experience, as consumers may be less annoyed to see a shifting quality of video than to have a video that stalls completely while more content is downloaded.

Adaptive video playback algorithms can be used to more rapidly provide the requested content by providing low bitrate video encodings and scaling up to higher bitrate encodings depending on the capability of the network to support higher bitrates.

While these techniques may avoid stalling or delaying the content delivery, the user experience may still be sub-optimal because the consumer may experience noticeably poor video quality for a period of time, particularly when the content is being initialized. Furthermore, a constant bitrate may provide an improved viewing experience as compared with a frequently changing video bitrate.

Embodiments described herein may facilitate the consumption of desired content on-demand, and may provide content at the desired quality level more rapidly. In some embodiments, a content caching system or apparatus can be used to assist delivery of the multimedia content.

The content caching system may also identify content representations to be pre-positioned in the content caching system at a consumer location. Pre-positioning content representations in a content caching system located at the consumer's location may reduce or eliminate some of the variability in content delivery. The content caching system may be coupled to the one or more client devices at the consumer premises over a local area network. If a requested content instance is pre-positioned at a consumer's premises, the content instance may be provided rapidly using the local network. Thus, regardless of the status of the wide area network between the consumer premises and a remote content delivery server, the desired content instance can be provided. In some embodiments, content representations may be pre-positioned during periods of low network usage or when a consumer's data usage policy or subscription provides for greater data usage or less costly data usage. As a result, demands on the wide area network may be further reduced during periods of high usage when content is delivered locally rather than over the wide area network.

Multimedia content a consumer is expected to request can be identified using the content caching system. The content caching system may identify, among other things, the content instances a consumer or consumers are expected to request (e.g. what movies or shows/episodes they are likely to watch), the representation types the consumer(s) may be capable of consuming (e.g. the representations the devices and players associated with that consumer are capable of playing), and the specific content representations the consumer is expected to request (e.g. what movie or shows does the consumer typically consume in certain formats/encodings). This may allow content to be pre-positioned for an individual or individual location. Tailoring the pre-positioning of content to individuals and/or locations may increase the likelihood that the pre-positioned content will be requested at that location.

In addition to pre-positioning content, the content caching system may also automatically adjust requests for content representations to improve delivery of the multimedia content. For instance, when a player requests a manifest file, the content caching system may intercept the manifest file from the content server. The content caching system may modify the received manifest file to add or remove one or more content representations so that content representations already stored in the content caching system are included in the manifest file. Accordingly, the player may select a content representation from the modified manifest file that corresponds to a pre-positioned content representation.

In some embodiments, if a player transmits a request for a particular content representation, the content caching system may determine that the content instance is present in the content caching system, but with a different representation type. In some cases, the content caching system may then provide the player with a pre-positioned content representation that has a different representation type than the requested content representation but is still the requested content instance.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming. Accordingly, the program code may be written in C, C⁺⁺ or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes. chips, and magnetic and electronic storage. In alternative embodiments, the medium may be transitory in nature such as, but not limited to, wire-line transmissions, satellite transmissions, Internet transmissions (e.g. downloads), media, digital and analog signals, and the like. The computer useable instructions may also be in various formats, including compiled and non-compiled code,

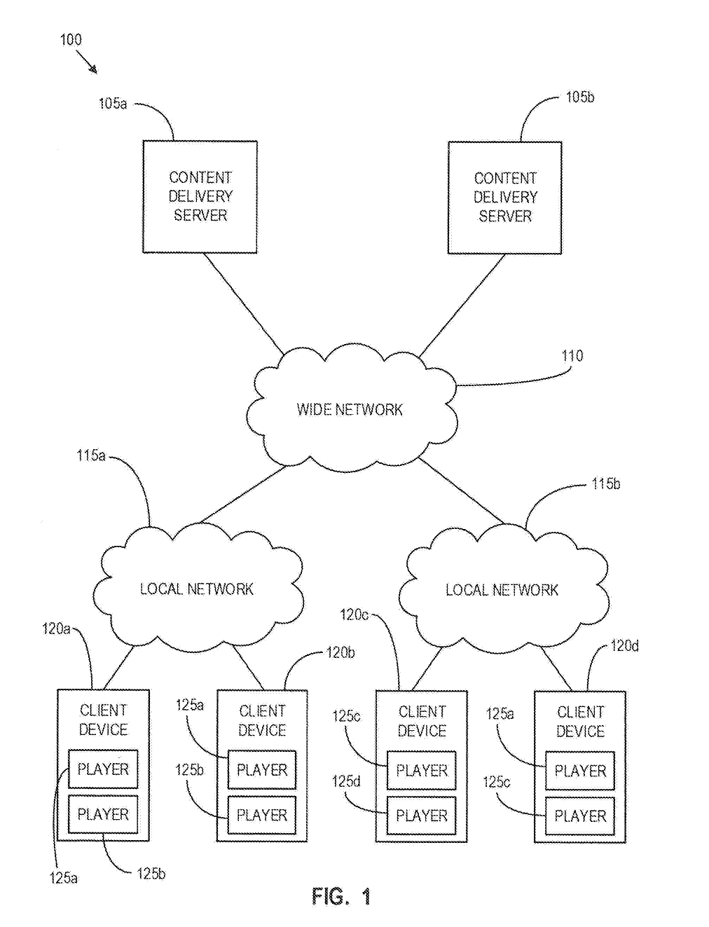

Referring now to FIG. 1, shown therein is block diagram illustrating an example embodiment of a system 100. The system 100 is provided as an example and there can be other embodiments of the system 100 with different components or a different configuration of the components described herein.

In general, the system 100 may include one or more content delivery servers 105. In the example of FIG. 1, system 100 includes content delivery servers 105a and 105b. Many components of the servers 105 may be implemented using a server computer, desktop computer, notebook computer, tablet, PDA, smartphone, or another computing device. IN general, each content delivery server 105 may include a processor, interface unit, memory, and one or more databases.

The content delivery servers 105 generally store content instances such as movies and TV shows in the one or more databases. The content delivery servers 105 may store one or more content representations corresponding to individual content instances. For example, each content representation for a particular content instance may refer to a different format or different bitrate encoding of a particular content instance.

The system 100 also includes a plurality of client devices 120a-120d. Each client device 120 may be associated with a particular consumer and/or a particular location, such as a consumer's home. The client devices 120 may include computers, mobile phones, tablets, gaming consoles, TV streaming boxes, and the like. The client devices 120 may include may include one or more of a processor, a memory, an input device, a display device, an output device, and a secondary storage device.

Each client device associated with a particular location may be connected to a local network, such as local networks 115a and 115b. The local networks 115 may be implemented using various networking techniques, such as using a Wi-Fi router. In some cases, the local network 115 may also be a single device such as a mobile phone on a mobile network. The local networks 115 may include wired and/or wireless connections.

Each local network 115 can be connected to a wide area network 110, such as the internet, via a wired and/or wireless connection. In some cases, network 110 may include other types of computer or telecommunication networks. The local networks 115 may be connected to wide area network 110 via an access network such as DSL, Cable, Satellite or fixed wireless. The access network can be connected to other networks on the Internet via a core network. The core network may use peering and transit techniques to reach other networks. The client devices 120 may communicate with the content delivery servers 105 using local network 115 and wide network 110 to request and receive content representations.

Each client device includes one or more players 125. Each player 125 may be a software application configured to decode and render received content representations suitable for display using the client device 120. For example, player 125 may a web browser or an application such as Netflix or Windows Media Player. Different client devices 120 may use different players 125 for instance because of the capabilities or operating system of the particular device 120. In the example shown in FIG. 1, devices 120a and 120b both have players 125a and 125b, while device 120c uses players 125c and 125d, and device 120d uses players 125a and 125c.

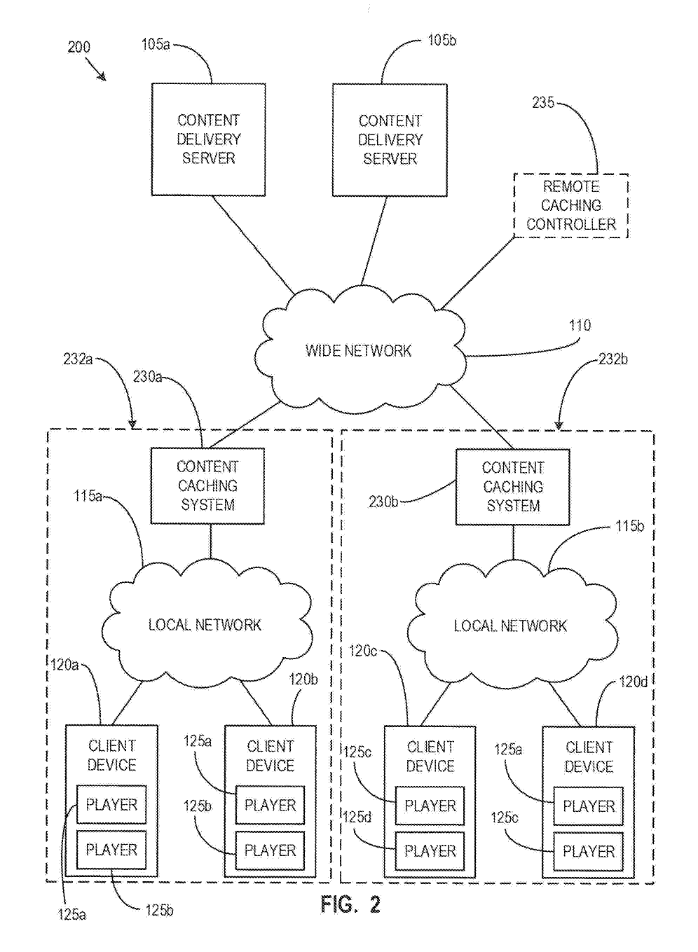

Referring now to FIG. 2, shown therein is a block diagram of a system 200 for providing multimedia content in accordance with an embodiment. The system 200 is provided as an example and there can be other embodiments of the system 200 with different components or a different configuration of the components described herein.

System 200 is similar to system 100, with the notable difference that content caching systems 230a and 230b are coupled to the client devices 125 over the local networks 115. The content caching systems 230 may each be associated with a particular location 232, such as a home or a place of business. The content caching system may also be located in a central location for a multi-unit building.

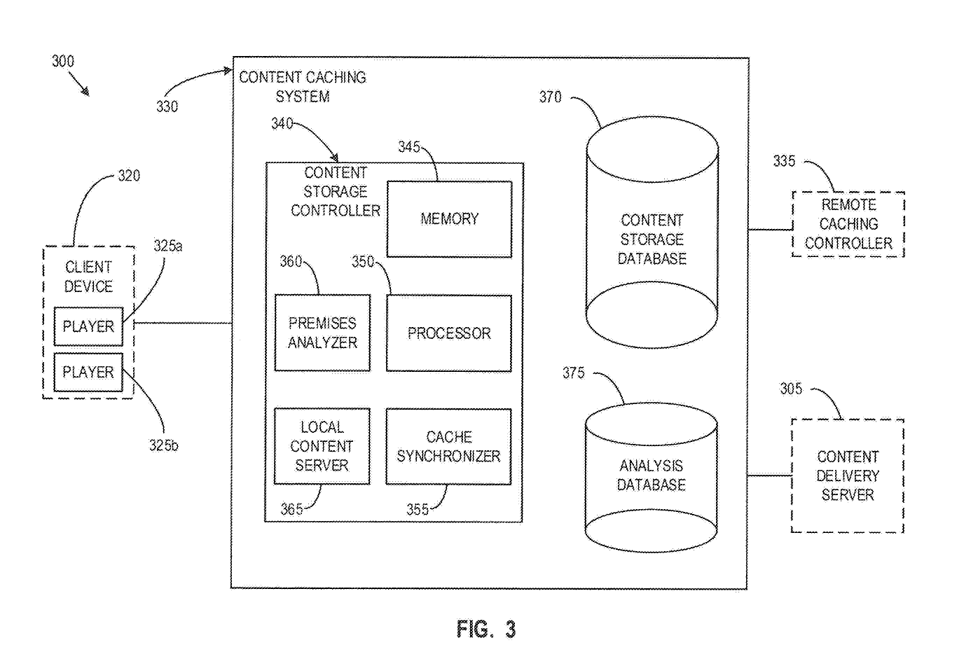

The content caching system 230 may be configured to monitor and/or intercept network traffic between wide network 110 and local network 115. The content caching system 230 may be provided as a separate hardware device, or it may be incorporated with one of the client devices 120. In some cases, the content caching system 230 may be provided as part of a router. In some cases, the functions of the content caching system 230 may be implemented using a software application installed as part of a player 125. An example embodiment of a content caching system will be described in further detail below with reference to FIG. 3.

Optionally, system 200 may also include a remote caching controller 235. The remote caching controller 235 may be used in conjunction with the content caching system 230 to monitor and analyze the traffic between wide network 110 and local network 115. In general, remote caching controller 235 may be implemented in hardware or software or a combination thereof, in a manner similar to servers 105. In some cases, various monitoring and analysis functions may be performed by the remote caching controller 235 with the content caching system 230 being used primarily to route data to the remote caching controller 235 for monitoring and analysis. That is, in some embodiments the content caching system 230 may operate primarily as a content storage device, with monitoring and analysis functions provided substantially or entirely by the remote caching controller 235 using the content caching system 230 simply to direct data to the remote caching, controller 235.

In some embodiments, the various monitoring and analysis functions may be performed by the remote caching controller 235 and the content caching system 230 in combination, with different aspects of the data analysis distributed between the remote caching controller 235 and the content caching system 230. For example, data may be monitored and analyzed locally on the content caching system 230 with statistics transmitted to the remote caching controller 235 for further analysis and/or for use in determining pre-position content representations at the remote caching controller 235,

In general, the servers 105, client devices 120, content caching systems 230, and remote caching controller 235 may be implemented using various combinations of hardware and software. For instance, the various devices may typically include processors, memory, and other operational components such as input or output devices, displays, interface units, communication units such as wireless units etc.

Input devices may include any device for entering information into a device. For example, an input device may be a keyboard, key pad, cursor-control device, touch-screen, camera, or microphone. In some cases, some of these components can be integrated with one another.

A display device may include any type of device for presenting visual information. For instance, the display may be a cathode ray tube, a flat-screen monitor and the like. In other cases, the display device may be a display suitable for a laptop, tablet or handheld device such as an LCD-based display and the like. The client devices 120 generally include displays that can be used to show content representations to users.

The interface unit may be any interface that allows a device to communicate with other devices or computers. In some cases, an interface unit may include at least one of a serial port, a parallel port or a USB port that provides USB connectivity. The interface unit may also include at least one of an Internet. Local Area Network (LAN) Ethernet, Firewire, modem or digital subscriber line connection.

In some cases, the devices may include a wireless unit such as a radio that communicates utilizing CDMA, GSM, CPRS or Bluetooth protocol according to standards such as IEEE 802.11a, 802.11b, 802.11g, or 802.11n. The wireless unit can be used to communicate with other devices or computers.

Referring now to FIG. 3, shown therein is a block diagram 300 illustrating the components of a content caching system 330. As block diagram 300 indicates, the content caching system 330 may be coupled to various other devices or systems, such as at least one client device 320, at least one content delivery server 305 and a remote caching controller 335 for example. The server 305, client devices 320, players 325, and remote caching controller 335 generally correspond to the servers 105, client devices 120, players 125 and remote caching controller 235.

The content caching system 330 may be communicatively coupled to the at least one client device 320 using a local connection such as a local network. The content caching system 330 may also be communicatively coupled to the at least one content delivery server 305 using a wide network, such as the Internet for example, and to the remote caching controller 335 over a wide network as well.

The content caching system 330 can include a content storage controller 340. The content storage controller may include a memory 345, a processor 350 and various operational components such as a cache synchronizer 355, a premises analyzer 360, and a local content server 365.

The processor 350 generally controls the operation of the content caching system 330 and can be any suitable processor, controller or digital signal processor that can provide sufficient processing power processor depending on the configuration, purposes and requirements of the content caching system 330 as is known by those skilled in the art. For example, the processor 350 may be a high performance general processor. In alternative embodiments, the processor 350 may include more than one processor with each processor being configured to perform different dedicated tasks. In alternative embodiments, specialized hardware can be used to provide some of the functions provided by the processor 350. In some cases, the functions of the processor 350 may be distributed between multiple devices.

Memory 345 may include random access memory (RAM) or similar types of memory. Also, memory 345 may store one or more applications for execution by processor 350. Processor 350 may execute applications, computer readable instructions or programs. Applications may correspond with software modules comprising computer executable instructions to perform processing for the functions described below. The applications, computer readable instructions or programs may be stored in memory 345, or may be received from the Internet or other networks. Memory 345 may also include secondary storage memory such as a hard disk drive, floppy disk drive, CD drive, DVD drive, Blu-ray drive, or other types of non-volatile data storage.

Premises analyzer 360 may be used to monitor and analyze traffic to and from client devices 320. In some cases, the premises analyzer 360 may operate as a transparent proxy where traffic is intercepted. In other embodiments, the content caching system 330 and premises analyzer 360 may operate as a server that client device connects to and requests data from. In some embodiments, the premises analyzer 360 may be implemented directly on the client device 320, e.g. as part of a player 325. In such eases, each device 320 may have a corresponding premises analyzer 360.

The premises analyzer 360 may be used to inspect network traffic, correlate network data into content representation streams, and analyze the streams for quality related metrics. The premises analyzer 360 may analyze the traffic to determine various statistics or data for the client devices 320.

The premises analyzer 360 may store various statistics and data in the analysis database 375. The analysis database 375 may maintain a registry of data/statistics for each client device 320 and each (client device 320, player 325) pair inspected using the premises analyzer 360.

Examples of client device statistics may include a maximum achieved bitrate of the device, a variance of bitrate, average bitrate, network drop rates etc, Examples of player statistics may include any adaptive algorithm(s) used, container types, codecs, resolutions, video quality metrics such as stall counts and bitrate changes, and results of previous optimization.

In some embodiments, the premises analyzer 360 may perform further analysis of the stored statistics to identify more general characteristics for the client devices 320, and/or the location associated with content caching system 330. In other embodiments, the monitored traffic data and/or statistics may be transmitted to the remote caching controller 335 for further analysis. For simplicity and clarity in the below description, various operations are described as being performed by a premises analyzer 360 located in the content caching system 330, although in some embodiments such operations may be performed by the remote caching controller 335 (e.g. the premises analyzer 360 may be implemented on the remote caching controller 335.).

For instance, device playback characteristics for each client device 320 may be determined using the content caching system 330, e.g. directly with a premises analyzer 360 on the content caching system 330, or by directing or passing data to the remote caching controller 335 for analysis. Device playback characteristics may define multimedia representation types playable using a particular client device 320. The device playback characteristics may be determined based on specifications of the client device 320 and/or players 325, and/or by inspection of representation types successfully played back using the client device 320.

A plurality of location-specific multimedia representation types can also be determined for the client devices 320 coupled to the content caching system 330 over the local network, using the content caching system 330, again either directly with a premises analyzer 360 implemented on the content caching system 330, or by directing or passing data to the remote caching controller 335 for analysis. Each location-specific multimedia representation type may be suitable for playback on at least one of the client devices 320 coupled to the content caching, system 330 over the location network. That is, the plurality of location-specific multimedia representation types may identify the group of representation types that may be played back by the devices at a particular location, or a subset of those representation types.

In some embodiments, the premises analyzer 360 may determine the location-specific multimedia representation types using the device playback characteristics for each client device 320. In other embodiments, the premises analyzer 360 may determine the location-specific multimedia representation types based on monitoring traffic to the location as a whole. For instance, the premises analyzer 360 may determine the location-specific multimedia representation types by identifying representation types previously, requested and/or played back at the location.

The premises analyzer 360 may also identify location-specific content indicators for the client devices 320. Location-specific content indicators may identify content expected to be requested for playback on one of the client devices 320. The location-specific content indicators may be determined based on content playback selections received at the content caching system 330. For example, if a first episode of a series is selected, the location-specific content indicators may identify the second episode as content expected to be selected for playback. In some cases, the location-specific content indicators may include requests for particular content instances to be pre-positioned.

The location-specific content indicators may be determined based on types of content (e.g. romantic comedies, vampires, noir film etc.) that may be more likely to be requested. These may be determined based on analysis of the traffic monitored by premises analyzer 360. In some cases, content preferences may also be identified directly by a user of the client device 320. These content preferences can be used to determine the location-specific content indicators.

The premises analyzer 360 may then identify a plurality of multimedia content instances from the content indicators. That is, the premises analyzer 360 may identify specific content instances using, the content indicators for the client devices 320.

The premises analyzer 360 and/or remote controller 335 may use the identified characteristics to identify a plurality of pre-position content representations to store in the content storage database 370. These pre-position content representations may be stored in the content storage database 370 prior to receiving a request for at least some of the pre-position content representations. The pre-position content representations may be identified based on the previously identified multimedia content instances and location-specific multimedia representation types.

Content storage database 370 can be used to store the pre-position content representations so they are available for playback by the client device 320 using the local network. The content storage database 370 may also store metadata about the pre-positioned content representations.

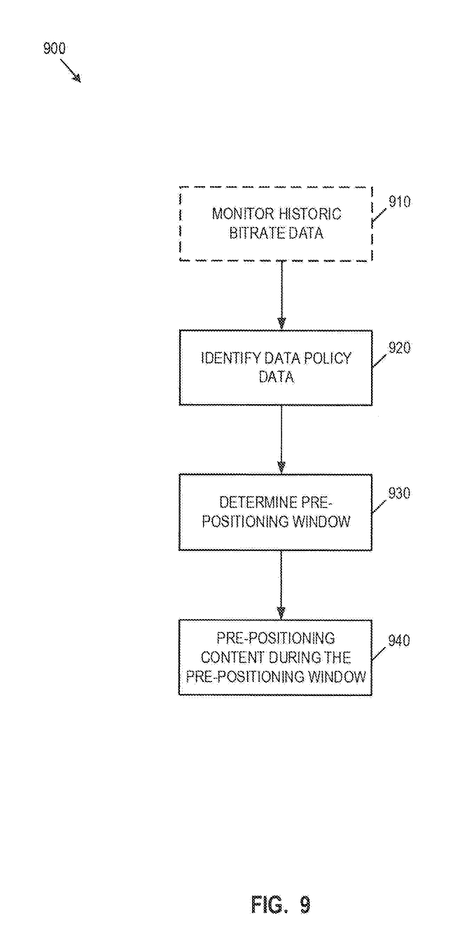

The cache synchronizer 355 may be used to determine the specific pre-position content representations to store, and when to store them. The cache synchronizer may make this determination based on data from the analysis database or by operating in concert with the premises analyzer 360 and/or remote controller 335. An example of the operation of the cache synchronizer 355 to determine a pre-position window is described below with reference to FIG. 9. The cache synchronizer 355 may also communicate with the content delivery server 305 to initiate and perform the process of downloading the pre-position content and storing it in the content storage database 370,

While in the example shown in FIG. 3, the premises analyzer 360, cache synchronizer 355 and analysis database 375 are provided as part of the content caching system 330, in alternative embodiments, the premises analyzer 360, cache synchronizer 355 and analysis database 375 and corresponding functionality may be provided by a remote caching controller 335. That is, the content caching system 330 may operate primarily as a content storage device for delivering content locally. The content caching system 330 may be used to route or direct data to the remote caching controller 335 for analysis and monitoring, e.g. where the remote caching controller 335 performs the functions of the premises analyzer 360, cache synchronizer 355 and analysis database 375. In some embodiments, the remote caching controller 335 may perform the functions of one or more of the premises analyzer 360, cache synchronizer 355 and analysis database 375 with the functions of the other one or more of the premises analyzer 360, cache synchronizer 355 and analysis database 375 performed by the content caching system 330 (as appropriate).

The content server 365 may be used to provide content representations in response to requests from client devices 320. The content server 365 may determine if corresponding pre-positioned content representations are available. When a client device 320 requests a content representation, the content server 365 may serve the requested content representation (or at least the corresponding content, instance) from content storage database 370 to optimize the delivery of the video.

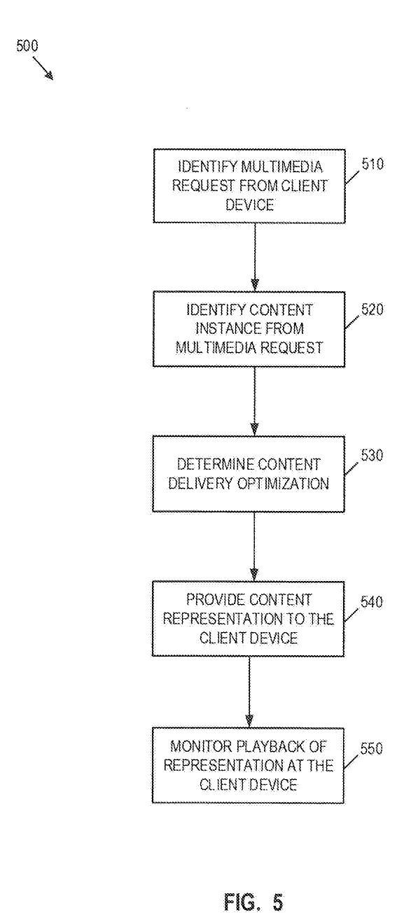

The content server 365 may consult the content metadata stored in content storage database 370 to identify the content representations (and corresponding content instances and representation types) stored in the content storage database 370. The content server 365 may also determine if any optimizations should be implemented in delivering the requested content. The content server 365 may access the data stored in analysis database 375 in determining if optimizations should be implemented, and what kind of optimization to implement. Aspects of the operation of content server 365 are described below with reference to FIGS. 5 to 7.

The content caching system 330 may generally be used to improve on-demand delivery of content representations. For example, the content caching system 330 may improve the startup quality of adaptive bitrate streaming video by pre-positioning the beginning of content instances, or the entire content instance, at a location that communicates with a client device 320 over a local network. As most network congestion occurs in the wide network 110 (the access or transit/peering networks), if the content is already available on the local network 115, higher quality content representations may be delivered more rapidly, and adaptive techniques may start at higher bitrate encodings of video. The content caching system 330 may also allow content representations to be time-shifted so they can be pre-positioned when the wide network 110 is less congested or idle, or when a consumer's data policy allows data transfer at higher bandwidth or reduced cost, and played when the wide network 110 is busy, making more efficient use of the network.

In general, content caching system 330 may be configured to communicate with a plurality of client devices 320 associated with a particular customer or location. The content caching system 330 may communicate with the plurality of client devices 320 over a local network such as local network 115 to function as a local cache for on-demand content representations.

In some embodiments, the content caching systems 230/330 may be implemented on a mobile device. In such embodiments, the content storage database 370 may be present directly on the device itself.

As discussed above, pre-positioning content may improve the quality of playback on client devices 320 by rapidly providing a high bitrate encoding of a video to a player. There may be several different players in a particular location, each capable of different resolutions and formats. While the ideal approach may be to pre-position all possible resolutions and formats of content likely to be requested (or content identified as being desirable in the further) into the content storage database 370, there are a number of constraints that limit this approach. The number of content representations that can be pre-positioned may be limited by the storage capacity of the content storage database 370, by the network capacity of wide network 110, and by data usage policies for the location and/or customer. For example, storing all formats and all resolutions of an hour-long show may take all of the storage available in the on-premises content caching system 330, so it is unable to serve other content. Accordingly, embodiments herein may provide methods that identify content instances to pre-position, and identifies representation types to pre-position (ideally that will minimize the cost of network access and storage, while maximizing the quantity and quality of playback).

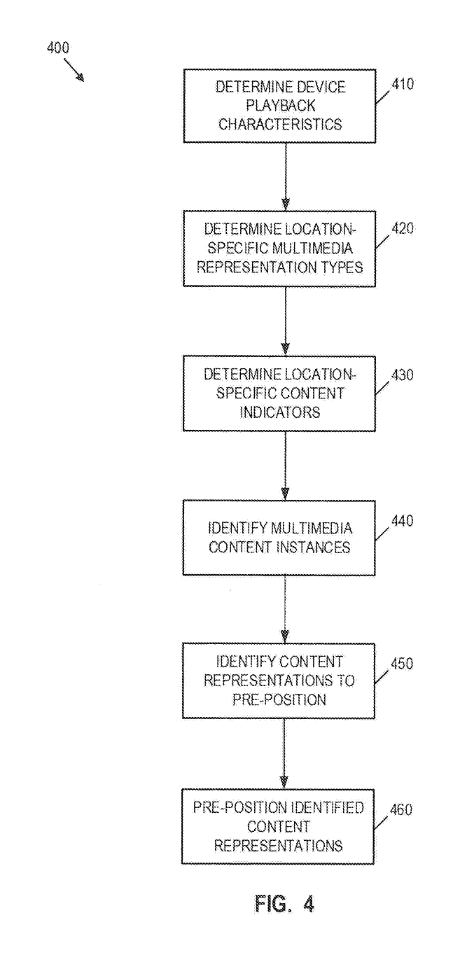

Referring now to FIG. 4, shown therein is a flowchart 400 of an example process for providing multimedia content to at least one client device, such as client devices 120. The process shown in flowchart 400 may be facilitated by providing a content caching system, such as content caching system 330, that is operable to communicate with the at least one client device. In some cases, the content caching system may be provided for a particular location associated with a plurality of client devices. In such cases, the content caching system may be operable to communicate with each of the client devices over the local network for that location.

At 410, device playback characteristics for each client device of the at least one client device can be determined using the content caching system. In general, the content caching system may be used to determine the playback characteristics directly, e.g. by identifying the playback capabilities of the devices or by monitoring playback by those players. In other cases, the content caching system may be used to determine the playback characteristics by operating, as a conduit to an off-site analysis module, such as may be provided by remote caching controller 335. The device playback characteristics for a particular client device can define multimedia representation types that are playable using that particular client device.

In some embodiments, the device playback characteristics may be determined based on the multimedia players available for multimedia playback on a particular client device. Using the content caching controller, at least one player-specific set of playback characteristics can be determined for each multimedia player available on a client device. The device playback characteristics for a client device may be determined to include the at least one player-specific set of playback characteristics for each multimedia player available on that device.

The player-specific set of playback characteristics may define the multimedia representations types that are playable using a particular multimedia player. For example, the set of playback characteristics may define the different combinations of bitrates and encoding algorithms that can be played back on a particular player. In some cases, the player-specific set of playback characteristics may also take into account the limitations of the device and/or the display associated with the device. For instance, where the resolution of the display is limited, the set of playback characteristics may be limited to representation types corresponding to the resolution of the display. In some embodiments, the playback characteristics of content representations previously requested and played back using a particular multimedia player may be used to determine the set of playback characteristics for a particular player.

At 420, a plurality of location-specific multimedia representation types can be determined for the at least one client device using the content caching system. Here again, the content caching system may determine the location-specific multimedia representation types directly, and/or by operating as a data conduit to an off-site analysis module. Each location-specific multimedia representation type is determined as a content representation that is suitable for playback on at least one particular client device associated with a particular location. For example, where a location has a plurality of client devices, the location-specific multimedia representation types may take into account the representation types suitable for playback on any one of the devices at a particular location.

For example, a content caching system may communicate with client devices including a Smart TV and an iPhone. If the Smart TV is capable of 1080 p resolution and the iPhone is capable of 720 p resolution, then representation types including both of these encodings may be identified as location-specific multimedia representation types. Similarly, if the Smart TV plays an HEVC format video, and the iPhone plays an AVC format video, representation types including both of these formats may be identified as location-specific multimedia representation types. If for instance the iPhone is not capable of 1080 p resolutions and the Smart TV cannot play an AVC format, then a representation type having a 1080 p resolution and an AVC format may not be included in the location-specific multimedia representation types.

In some embodiments, the content caching system may be used to monitor playback on the client devices. This may include monitoring representation type data that defines multimedia representation types played back using one of the client devices. Preferred content representation types may be determined based on the monitored representation type data.

At 430, location-specific content indicators can be determined using the content caching system. The location-specific content indicators may indicate content types more likely to be requested by the client devices operable to communicate with the content caching system.

In some embodiments, location-specific content indicators may be determined based on user input. For example, the location-specific content indicators may be determined based on content playback selections received from a client device. The requested content may be used to determine additional content expected to be requested. For instance, if the first episode of a series is requested, the location-specific content indicators may be determined to identify the second episode as a content instance expected to be requested.

In some embodiments, the location-specific content indicators may include monitoring user-indicated content preferences received by the content caching system. For instance, a user may provide input to one of the client devices indicating a specific content instance, or content type, that user prefers.

In some embodiments, the location-specific content indicators may be determined based on historic use of the client devices. Determining the location-specific content preferences may include monitoring historic content type data for the client devices using the content caching system. The historic content type data may define at least content type previously played using the at least one client device. In some cases, preferred content types can be determined from the monitored historic content type data. The location-specific content indicators may then be determined based on the preferred content types. For instance, the location-specific content indicators may be determined by identifying a preference for a particular type or types of movie or TV show (e.g. romantic comedy, Kung Fu, drama, documentary etc.).

At 440, the content caching system can determine a plurality of multimedia content instances based on the location-specific content indicators. For example, the content caching system may determine that certain movies and/or TV shows and/or other content instances are expected to be requested by the client devices. Accordingly, these content instances may be identified in the plurality of multimedia content instances. In some cases, the content instances may be identified taking into account other factors such as timing. For instances, the client device historic content type data may indicate a preference for movies on the weekend and TV shows during the week. The content caching system may take such preference data into account when determining the plurality of multimedia content instances.

At 450, a plurality of pre-position content representations can be determined for storage in the content caching system. The pre-position content representations can be determined prior to receiving a request for at least some of the pre-position content representations. The plurality of pre-position content representations can be identified based on the plurality of multimedia content instances and the plurality of location-specific multimedia representation types for the client devices in local communication with the content caching system. In general, each pre-position content representation corresponds to one of the multimedia content instances and to one of the multimedia representation types from the plurality of location-specific multimedia representation types.

In some embodiments, the content caching system 330 may identify the pre-position content representations by determining that specific combinations of content types and representation types are more likely to be requested. For instance, the content caching system 330 may determine that action movies are almost always played back using high bitrate client devices, while comedic sitcoms are played back at lower bitrates. Accordingly, the pre-position content representations may be determined taking such combinations into account.

In other cases, the pre-position content representations may be determined primarily on the basis of the content instances expected to be requested by the client devices. Accordingly, the pre-position content representations may be identified almost solely on the basis of the identified multimedia content instances determined at 440, without preferring any particular representation types (apart from excluding those that cannot be played back by the client devices at a location).

At 460, at least some of the pre-position content representations determined at 450 can be stored in the content caching system. The pre-position content representations stored in the content caching system can then be made available for playback by the at least one client device using the local network.

In some embodiments, the pre-position content representations determined at 450 may include content representation portions. For instance, the initial portion of particular content representations may be determined as pre-position content representations. Rather than pre-positioning entire content representations, pre-position content representation portions may allow a greater number of content instance/representation type combinations to be pre-positioned. This may improve the likelihood that at least the initial portion of a requested content representation (or the corresponding content instance) is pre-positioned. This may in turn improve the startup quality for a greater number of requested content instances taking into account storage limitations of the content storage database 370.

The pre-position content representations can be stored in the content caching system by transmitting the pre-position content representations from the content servers over the wide network. In some embodiments, the pre-position content representations may be transmitted only during particular windows, e.g. when a consumer's data usage policy allows greater data transfer, or less expensive data transfer, or when network usage is low, as will be discussed in further detail with reference to FIG. 9 below.

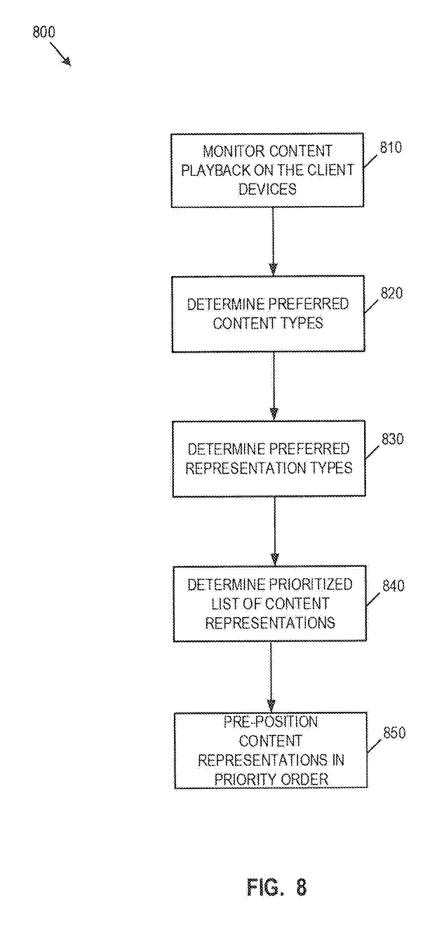

In some embodiments, a prioritized list of pre-position content representations may be determined from the plurality of pre-position content representations determined at 450. The pre-position content representations can be stored in the content caching system in priority order using the prioritized list of pre-position content representations as will be discussed in further detail below with references to FIG. 8.

Storing the pre-position content representations in the content caching system may facilitate on-demand playback of particular content instances. When a content instance is requested by a particular client device, rather than having to transmit the content representations over the wide network at the time of the request, a content representation corresponding to the requested content instance may already be stored in the content caching system. Accordingly, the requested content may be provided over the local network more rapidly than would otherwise be possible.

Referring now to FIG. 5, shown therein is a flowchart 500 of an example process for providing multimedia content. The process shown in flowchart 500 may be implemented using various components of content delivery system 200 and/or content caching system 330. The process shown in flowchart 500 may be used to improve quality of content representations provided to consumers, and in particular may improve the initial quality of the content representations provided.

At 510, a multimedia request can be identified from one of the client devices 120. The content caching system may determine from the multimedia request that a request for content playback has been initiated by user input at the client device. The multimedia request may indicate that a new content session is desired.

At 520, a content instance can be identified from the multimedia request. In general, the multimedia request identifies a particular content instance that a consumer is requesting at the client device. The content caching system can determine from the multimedia request the specific content instance that has been requested for playback by a user.

At 530, the content caching system may identify a content delivery optimization for the requested content playback. In some cases, for example, if a content representation corresponding to the requested content instance is not present in the content caching system, the content caching system may determine that adaptive Nitrate streaming from the content delivery server is to be implemented. In other cases, if a pre-position content representation corresponding to the requested content instance is stored in the content caching system various optimizations may be used.

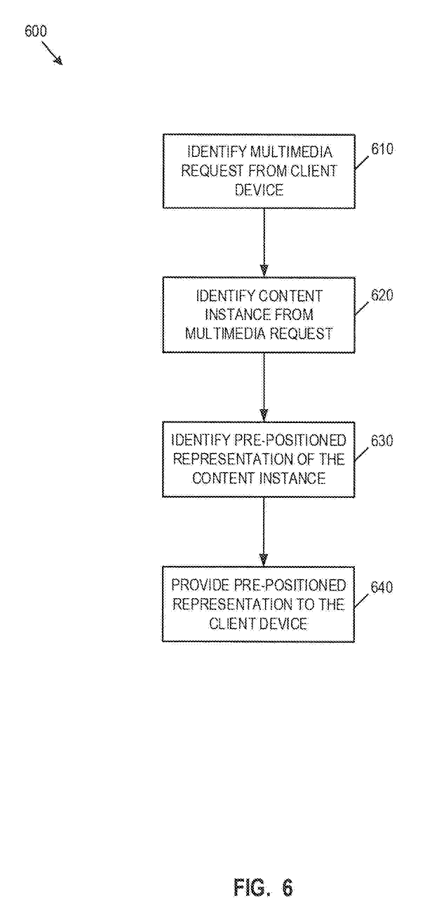

For example, the content caching system may determine that the video session should be optimized by substituting the requested content representation with a pre-position content representation stored in the content storage database. An example of a content replacement optimization will be discussed in further detail below with reference to FIG. 6.

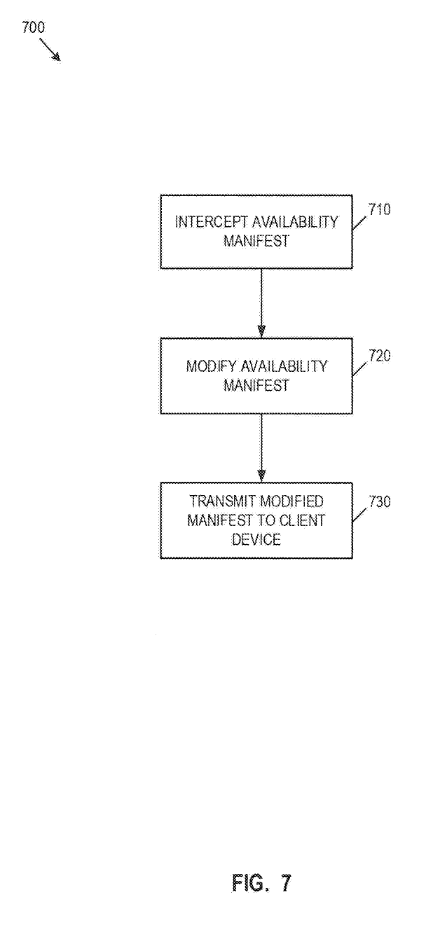

In some embodiments, the client device first requests metadata (also referred to as a manifest file) from a content server indicating the content representations available. In such cases, the content caching system may replace or modify the manifest file received from a content server to reflect pre-position content representations stored in the content caching system. An example of a manifest replacement optimization will be discussed in further detail below with reference to FIG. 7.

In some cases, the optimization may be determined based on the outcome of previous optimizations. For instance, if a previous optimization failed for some reason, then the session may not be optimized, to maximize the quality of the user's experience.

The optimization may be determined taking into account analysis of previous traffic to the client device and/or location, as well as a current state of the wide network. In some cases, the optimization may be determined locally, e.g. by the content server 365 using data stored in analysis database 375. In other cases, the optimization may be determined based on communication with the remote controller 335.

In some cases, the optimization may include requesting and providing a content representation from the content delivery server 105. For example, if a content representation corresponding to the content instance is not pre-positioned in the content caching system, then a content representation must be retrieved from the content delivery server 105 over the wide network 110. In some cases, a content representation may be requested from the content delivery server 105 even if a content representation is pre-positioned. For example, if the request for content occurs at a time when the wide network 110 has a lot of bandwidth available then the content representation may be requested and transmitted from the content delivery server 105. This may be desirable, for instance if the pre-positioned content representation is a lower bitrate encoding, but the requesting player is capable of providing a higher bitrate and the wide network has the bandwidth to accommodate the request.

At 540, a content representation can be provided to the client device. The provided content representation corresponds to the content instance requested by the client device. In some cases, the particular content representation provided may be determined based on the optimization selected at 530.

At 550, playback of the content representation provided at 540 may be monitored. Monitoring the playback of the provided content representation may include monitoring quality metrics for the content representation playback. The quality metrics may include the number of times the player buffer under-flows—i.e. causing the player to stall the video until more data can be downloaded by the player. The monitored quality metrics can be stored using the content caching system for analysis. Analysis of the quality metrics may be used to determine if the content representation is suitable for playback by the player and/or device, and if the optimization selected at 530 was successful or not. Various thresholds may be defined either manually, or by the content caching system, to determine if playback is successful.

In some cases, the monitoring may identify quality issues with the content representation feedback. The content caching system may then attempt to resolve the playback quality issues. For example, the content caching system may prioritize network traffic for the video playback over other network traffic being monitored by the content caching system. In other cases, the content caching system may dynamically trans-code or trans-rate the content representations being provided to improve playback quality at the expense of the picture quality of the video. In some cases, the content caching system may select an alternative optimization technique for the content session if the current optimization is not providing sufficient quality playback, such as selecting a content representation having a different representation type. In such cases, the player may be forced to restart the content session to allow the alternative optimization to be implemented.

Referring now to FIG. 6, shown therein is a flowchart 600 of an example process for providing multimedia content. The process shown in flowchart 600 may be implemented using various components of content delivery system 200 and/or content caching system 330. The process shown in flowchart 600 is an example process for providing a requesting content instance when a content representation corresponding to the requested content instance is pre-positioned in the content storage database.

At 610, a multimedia request can be identified from a particular one of the client devices 120. The content caching system may determine from the multimedia request that a request far content playback has been initiated by user input at the client device. The multimedia request may indicate that a new content session is desired.

At 620, a content instance can be identified from the multimedia request. In some cases, the content instance may be identified by the content caching system directly from the multimedia request. In other cases, the multimedia request may be transmitted to a content server, and the content instance may be determined based on a response from the content server that was generated based on the multimedia request.

In general, the multimedia request identifies a particular content instance that a consumer is requesting at the client device. The content caching system can determine from the multimedia request (either directly or from the server response) the specific content instance that has been requested for playback by a user. In some cases, the multimedia request may also identify a particular requested multimedia representation type.

At 630, a particular pre-position content representation stored in the content caching system that is a representation of the particular multimedia content instance requested is identified. As the content caching system has identified a pre-position content representation matching the requested content instance, the content caching system may determine that the pre-position content representation should be provided to the client device.

For example, if the pre-position content representation corresponds to a multimedia representation type playable using the requesting client device and the requesting player, the content caching system may provide that pre-position content representation to the client device.

In some embodiments, there may be more than one stored pre-position content representation corresponding to the requested content instance. The content caching system may then select from among these pre-position content representation to provide the content instance for the client device. For example, the content caching system may analyze historical playback data for the device to determine which pre-position content representation to provide. The content caching system may identify a highest resolution content representation suitable for playback using the requesting device and/or player. The content caching system may provide the identified highest resolution content representation to the client device. For example, if the device has been able to reliably consume content at the highest stored resolution, with the player app requesting the content instance, then the content caching system may provide the content representation having this resolution.

At 640, the particular pre-position content representation identified at 630 can be provided to the particular client device. The provided content representation may allow the client device to play the requested multimedia content instance.

As mentioned above, the multimedia request may identify a particular requested multimedia representation type. In some embodiments, the content caching system may provide the client device with a pre-position content representation corresponding to the requested content instance that has a representation type different from the requested multimedia representation type. For example, the device and/or player may request a content representation that is a 256 Kbps encoding of a video file. The content caching system may determine that a 3 Mbps encoding of the video file is pre-positioned and suitable for playback on the device. Accordingly, the content caching system may provide the higher resolution content representation to the client device. In general, if the content caching system provides a content representation of a representation type different from that requested, the content caching system may then continue to provide the content representation of the different representation type for the entirety of the video session. If monitoring of the playback indicates that an alternative content representation should be provided, e.g. because quality metrics are poor, then the playback may need to be re-started.

In some cases, the player on a client device may not support providing a content representation of a different type. Accordingly, it may be necessary to consult the data in the analysis database 375 to determine if a different representation type may be provided.

Referring now to FIG. 7, shown therein is a flowchart 700 of an example process for providing multimedia content. The process shown in flowchart 700 may be implemented using various components of content delivery system 200 and/or content caching system 330.

In some cases, the multimedia request from the client device may include a request for available multimedia representation types for a particular multimedia content instance being requested. In some cases, prior to requesting a particular content representation a player may request metadata (e.g. a manifest file) from a content server corresponding to the content instance being requested.

In general, the content caching system will determine from the multimedia request (i.e. using data in the request directly, or using data in a server response to the request) if there is a pre-positioned content representation corresponding to the requested content instance. If so, then the content caching system may intercept and modify an availability manifest.

At 710, the content caching system may intercept an availability manifest being transmitted to the particular client device. The availability manifest corresponds to the metadata requested by the player corresponding to the content instance to be requested. In general the availability manifest identifies at least one initial available multimedia representation type that is corresponds to a content representation of the requested content instances.

At 720, the content caching system may modify the availability manifest prior to the availability manifest being transmitted to the player. In some cases, the content caching system may remove one of the initial available multimedia representation types from the availability manifest and/or add an additional available multimedia representation types to the availability manifest. For example, the content caching system may remove initial available multimedia representation types that are not available as pre-position content representations or add additional available multimedia representation types that are available as pre-position content representations.

In some cases, the content caching system may first determine that the pre-position content representation can be played back using the requesting player. The content caching system may then modify the availability manifest so that preferred content representations will be requested by the player. For instance, representation types having a lower bitrate that may otherwise be requested by the player initially may be removed from the manifest to force the player to request a higher bitrate representation type.

In some cases, the content caching system may also modify URLs in the manifest. The URLs may be modified so the player requests content representations directly from the content, caching system. In other cases, the content caching system may not modify the URLs, but may intercept requests to the content delivery server and transparently provide the pre-positioned content locally.

In some cases, the content caching system may decrypt the manifest file prior to modifying the availability manifest. In many cases, the content instance being requested may be protected or encrypted for various reasons. For instance, many content instances are copyrighted works. To protect against unauthorized copying and playback of copyrighted content instances, the content representations may be encrypted using Digital Rights Management (DRM) technology. In some cases manifests may also be encrypted as they transit the network between the server and the player.

At 730, the content caching system may then transmit the modified availability manifest to the requesting client device. The client device may then use the modified availability manifest to select particular content representation types to request.

Referring now to FIG. 8, shown therein is a flowchart 800 of an example process for pre-positioning multimedia content. The process shown in flowchart 800 may be implemented using various components of content delivery system 200 and/or content caching system 330. The process shown in flowchart 800 is an example of a process for pre-positioning multimedia content using a prioritized list of pre-position content representations.

At 810, the content caching system can be used to monitor playback on the client devices. Monitoring playback can include monitoring historic representation type data that defines at least one multimedia representation type previously played back using one of the client devices. Monitoring playback can also include monitoring historic content data (including content type data and content instance data) that defines at least one content type and/or at least one content instance previously played back using one of the client devices.

At 820, preferred content types may be determined from the historic content type data monitored at 810. The preferred content types may be determined by identifying types of content that are played back most often by the client devices. Examples of preferred content types may include romantic comedies, horror movies, animated kids shows etc. In some cases, this may also take into account time period specific interests (e.g. different content may be preferred seasonally, or at certain times of the year such as Christmas).

Content instance sequences may also be identified from the historic content data monitored at 810. For example, if a consumer watches a content instance corresponding to season 1 episode 5 of a particular TV show, the content instance sequence may indicate that season 1 episode 6 (and episode 7 and so on) may be expected to be requested by the user. In some cases, the content instance sequences may be determined by identifying a probability that a comparable user will request the subsequent instance in the sequence, for example because historic data monitored by the remote caching controller indicates that a certain percentage of users request movie Y after movie X.

At 830, preferred representation types may be determined based on the monitored historic representation type data. Each of the preferred content representation type corresponds to one of the monitored historic representation type data. The preferred content representation types may indicate content representation types that are most often played back using the client devices. For instance, the monitored representation type data may indicate that particular bitrates are most often played back using the client devices e.g. 3 Mbps, while other bitrates are seldom selected e.g. 256 Kbps. Accordingly, the content caching system may determine that the representation typos having a 3 Mbps are preferred for playback using the client devices.

At 840, a prioritized list of pre-position content representations can be determined. As explained above, a plurality of pre-position content representations may be determined using identified multimedia content instances and location-specific multimedia representation types. The prioritized list can be determined from the plurality of pre-position content representations.

The prioritized list may be determined by identifying expected content representations using expected or preferred content types from 820 and preferred representation types from 830. The preferred content representations may also take into account that certain content types may be more likely to be requested in certain representations types (e.g. action at high bitrates, sitcoms more indifferent bitrates).

At 850, the at least some of the pre-position content representations from the plurality of pre-position content representations can be stored in priority order using the prioritized list of pre-position content representations. In some cases, the content representations may be stored in order based on the prioritized list until the storage database is full. In other cases, storage of pre-position content representations may be limited by data usage policies, network status or pre-position windows etc. An example of a method for scheduling the pre-positioning of content taking into account some of these factors is described below with reference to FIG. 9.

In some embodiments, a location-specific content threshold may be determined for the content caching system. The location-specific content threshold may define a minimum amount of content to be pre-positioned (e.g. a certain time amount of content instances). The location-specific content threshold may be user-set, or may be determined based on analysis of historic traffic monitored by the content caching system.

An available storage capacity of the content storage database may be determined. The stored content level of the content storage database may also be determined. The stored content level define the amount of pre-position content representations currently stored in the content storage database of the content caching system. The prioritized list of pre-position content representations can then be determined based on the location-specific content threshold, the stored content level and the available storage capacity. In some cases, rather than storing the highest quality representation types possible, the prioritized list may be determined to store a greater amount of content at a lower bitrate representation type to ensure a higher likelihood that the requested content is pre-positioned.

In some cases, the prioritized list may be defined based on a priority of content instances. Content representations may then be stored in an iterative manner, using the prioritized list of content instances. For example, content representations may be stored initially at lower quality and higher quality content representations may be provided at subsequent iterations. In some cases, the initial content representations may be stored in representation types suitable for the greatest number of client devices in communication with a content caching system. For instance, the content representations with the highest quality representation types that are suitable for playback on all client devices at a particular location may be identified with the highest priority.

Consider a location with both a Smart TV and Phone. If both devices are capable of 720 p resolution then content representations having this resolution may be given higher priority and stored in a first iteration. In a subsequent iteration_{;} content representations with representation types having 1080p may be added if there is remaining storage capacity.

Referring now to FIG. 9, shown therein is a flowchart 900 showing an example process for pre-positioning content representations using a pre-positioning window. The process shown in flowchart 900 may determine a pre-positioning window taking into accounts various factors, such as limits on data transfer between the content caching system and the wide network. A historically achieved bitrate for downloading content from the content delivery servers may also be considered.

At 910, in some cases historic bitrate data can be monitored. The historic bitrate data may define a historically achieved data transfer or download bitrate between the content caching system and an external network.

In some cases, the historic bitrate data may be determined using an overall average bitrate, or a moving average bitrate. In other cases, the historic bitrate data may also take into the historic bitrate for a particular period such as a day and/or the time of day.

At 920, data policy data may be determined for the content caching system. The data policy data may define limits on data transfer between the content caching system and the external network. In some cases, the data policy data may also identify permissible pre-positioning time periods, such as off-peak times.

The data policy data may define various data transfer parameters. For example, the data policy data may define an off-peak time period. The off-peak time period may represent a time period where wide network use is lower and/or the cost to access the wide network is lower. For example, an off-peak time period may be 2 am-8 am.

The data transfer parameters may also define data transfer allowances for a location or individual. Anytime allowance may define an initial total amount of allowed bytes that may be transferred to content caching system at any time during a usage period (e.g. a month). Off-peak allowance may define an initial total amount of allowed bytes that may be transferred to content caching system during the off-peak time period.

In some cases, the data policy data may be determined based on a subscription for the content caching system and/or associated location. This may also take into account current remaining off-peak allowance and anytime allowance remaining for the current time period associated with the subscription (e.g. each billing cycle). The data transfer parameters may also include a reset date/time, when the data transfer allowances may be reset. The data policy data may also be set directly by a user providing input to the content caching system.

In other cases the limits on data transfer may be imposed by the wide network and/or a local network to limit the bandwidth consumed by the content caching system so as not to interfere with network bandwidth for other data transfers.

In some cases, a specific data policy may not be defined for a particular location or customer. Accordingly, the content caching system may have a pre-set or default limit on data transfer to the content caching system. For instance, the default data policy data may define an unlimited data transfer limit for the content caching system. In some cases, the default data policy data may also define the permissible pre-positioning time periods to be unrestricted.

In some cases, network congestion may also be monitored. Network congestion may be monitored to determine periods when higher data transfer rates are likely to be achievable between the content caching system and the content server.

At 930, a pre-positioning window can be determined. The pre-positioning window can be determined using the data policy data from 920. A pre-positioning window may be determined as a particular date and/or time period during which content representations can be pre-positioned in the content caching system. For example, the pre-positioning window may be determined as the off-peak time period to minimize consumption of the anytime data allowance for a user.

A window download allowance may also be determined based on the historic bitrate data from 910 and/or the data policy data from 920. For example, the historic bitrate data may enable the content caching system to determine the number of bytes, and corresponding amount/number of content representations that can be pre-positioned during the window. The data policy data may define limits on the window download allowance, e.g. based on remaining data allowances for the current time period, and or cost considerations for example.

In some embodiments, a pre-position window may be determined by identifying remaining data allowances for various times or periods. If there is remaining off-peak data allowance, off-peak time periods may be used to pre-position content representations. In some cases, the pre-position windows may be limited to off-peak periods to reduce associated costs and usage of anytime data allowance. This may also reduce strain on the wide network. The next pre-position window may be determined as the next off-peak time period, and a window data allowance limit may be determined based on the total remaining off-peak data allowance and the number of remaining off-peak time periods in a cycle (e.g. by dividing the total off-peak data allowance remaining by the remaining off-peak periods remaining before the reset time). This may ensure that even at the end of a billing cycle, there will be off-peak data left for pre-positioning shows.

If there is remaining allowance for anytime data transfer, the pre-position window may even be determined to include pre-positioning content during the peak or anytime periods. This may allow data to be pre-positioned at higher usage time periods for the network, e.g. if the time period does not correspond to a period when the specific consumer or location requests content. This may desirable for example where a user typically requests playback during off-peak periods, so that pre-positioning does not consumer bandwidth that may be needed to provide requested content.

In some cases, the pre-position window can also be determined taking into account monitored network congestion. For instance, the pre-position window may be determined to achieve a threshold data transfer rate between the content caching system and the content server.

At 940, content representations can be pre-positioned in the content caching system during the pre-positioning window. The content representations may be stored during the pre-positioning window using various methods as described herein, such as using a prioritized list of content, and/or ensuring that a minimum amount of content is stored.

In some embodiments, a set of window content representations may be identified to be pre-positioned during a particular pre-positioning window. The set of window content representations may be determined from among the pre-position content representations, such as those determined at 450.

The set of window content representations may be determined based on a total data size of the content representation files to be pre-positioned during a particular window. In some cases, the set of window content representations may be determined to maximize the amount of content to be pre-positioned based on the window download allowance and the data size of various pre-position content representations. For example, additional content representations may be added to the set of window content representations until no additional pre-position content representations can fit within the window download allowance.

In some embodiments, the set of window content representations may be determined based on a location-specific content threshold of content to pre-position in the content caching system. The set of window content representations may be determined to maximize the quality of the content representations that are pre-positioned, while also ensuring that the location-specific content threshold is met. For example, a location-specific content threshold may be to have 20 hours of video content available per day. In some cases, the highest quality representation types may be determined to satisfy the location-specific content threshold and the window download allowance concurrently. In some cases, 20 hours of content may be initially pre-positioned at a lower quality, and higher quality encodings of that content may be pre-positioned before adding the minimum quality encodings of other content representations,

In some embodiments, the content caching system may determine that a particular pre-position window should be modified. For example, the content caching system may determine that a streaming video session is currently ongoing at the location during the next schedule pre-position window. In some cases, pre-positioning may also be interrupted or stopped if a request for a content representation is received during the pre-positioning window. Accordingly, the pre-position window may be delayed or adjusted so as not to interfere with the ongoing video session.

In some alternate examples, aspects of the various embodiments described herein may also be implemented to improve delivery of live, or substantially live events, such as live sporting events or political debates for example. In such embodiments, content may be pre-positioned on a substantially real-time basis, where one or more content representation portions may be pre-positioned a short time period, e.g. minutes, in advance of being played, to reduce the potential impact of congestion in the access or transit network.

The present invention has been described here by way of example only. Various modification and variations may be made to these exemplary embodiments without departing from the spirit and scope of the invention, which is limited only by the appended claims.

We claim:

1. A method for providing multimedia content to at least one client device, the method comprising:
providing a content caching system operable to communicate with the at least one client device over a local network;
determining device playback characteristics for each client device of the at least one client device using the content caching system, the device playback characteristics for a particular client device defining multimedia representation types playable using, that particular client device;
determining a plurality of location-specific multimedia representation types for the at least one client device using the content caching system, each location-specific multimedia representation type suitable for playback on a particular client device of the at least one client device;
determining location-specific content indicators for the at least one client device using the content caching system;
identifying a plurality of multimedia content instances based on the location-specific content indicators using the content caching system;
identifying a plurality of pre-position content representations to store in the content caching system prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and
storing at least some of the pre-position content representations in the content caching system, wherein each pre-position content representation stored in the content caching system is available for playback by the at least one client device using the local network.

2. The method of claim 1, wherein, for each client device, determining the device playback characteristics comprises:
identifying at least one multimedia player available for multimedia playback on that client device;
for each multimedia player, determining at least one player-specific set of playback characteristics, each player-specific set of playback characteristics defining multimedia representation types playable using that multimedia player; and
determining, the device playback characteristics for that client device to include the at least one player-specific set of playback characteristics for each multimedia player.

3. The method of claim 1, wherein the storing of at least some of the pre-position content representations in the content caching system comprises:
determining a prioritized list of pre-position content representations from the plurality of pre-position content representations; and
storing the at least some of the pre-position content representations from the plurality of pre-position content representations in priority order using the prioritized list of pre-position content representations.

4. The method of claim 3, wherein determining the prioritized list of pre-position content representations comprises:
monitoring, using the content caching system, historic representation type data, the historic representation type data defining at least one multimedia representation type previously played back using the at least one client device;
determining preferred content representation types based on the monitored historic representation type data, each preferred content representation type corresponding to one of the location-specific multimedia representation types;
identifying preferred content representations as pre-position content representations in the plurality of pre-position content representations corresponding to one of the preferred content representation types; and
determining the prioritized list using the preferred content representations.

5. The method of claim 3, further comprising:
identifying a location-specific content threshold of the content caching system, the location-specific content threshold defining a minimum amount of content to be pre-positioned;
determining an available storage capacity in the content caching system;
determining a stored content level defining an amount of pre-position content representations currently stored in the content caching system; and
the determining the prioritized list of pre-position content representations is based on the location-specific content threshold, the stored content level and the available storage capacity.

6. The method of claim 1, further comprising:
determining a pre-positioning window using data policy data for the content caching system, the data policy data defining limits on data transfer between the content caching system and the external network; and
wherein the storing of the at least some of the pre-position content representations occurs during the pre-positioning window.

7. The method of claim 6, further comprising:
determining a window allowance for the pre-position window using historic bitrate data for the content caching system, the historic bitrate data defining a historically achieved download bitrate between the content caching system and an external network; and
wherein the storing of the at least some of the pre-position content representations during the pre-positioning window is limited by the determined window allowance.

8. The method of claim 1, wherein determining the location-specific content indicators comprises:
monitoring, using the content caching system, historic content type data, the historic content type data defining at least content type previously played using the at least one client device;
determining preferred content types from the monitored historic content type data; and
determining the location-specific content indicators using the preferred content types.

9. The method of claim further comprising:
identifying by the content caching system a multimedia request from a particular client device of the at least one client device, the multimedia request defining a particular multimedia content instance to be played at the particular client device;
identifying a particular pre-position content representation stored in the content caching system that is a representation of the particular multimedia content instance requested; and
providing the particular pre-position content representation to the particular client device for playing the particular multimedia, content instance.

10. The method of claim 9, wherein
the multimedia request identifies a requested multimedia representation type; and
the multimedia representation type corresponding to the particular pre-position content representation is different from the requested multimedia representation type.

11. The method of claim 9, wherein
the multimedia request defines a request for available multimedia representation types for the particular multimedia content instance; and
the method further comprises
intercepting by the content caching system an availability manifest being transmitted to the particular client device, the availability manifest identifying at least one initial available multimedia representation type;
modifying by the content caching system the availability manifest by at least one of removing one of the initial available multimedia representation types and adding an additional available multimedia representation types; and
transmitting the modified availability manifest to the particular client device,

12. An apparatus for providing multimedia content to at least one client device associated with a location, the apparatus comprising:
a content caching system, the content caching system communicatively coupled to the at least one client device over a local network and to at least one content delivery server over a wide network, the content caching system comprising;
a content storage database; and
a content storage controller having a processor and a memory;
wherein
the content storage controller is configured to:
determine device playback characteristics for each client device of the at least one client device, the device playback characteristics for a particular client device defining multimedia representation;
types playable using that particular client device;
determine a plurality of location-specific multimedia representation types for the at least one client device, each location-specific multimedia representation type suitable for playback on a particular client device of the at least one client device;
determine location-specific content indicators for the at least one client device;
identify a plurality of multimedia content instances from the location-specific content indicators;
identify a plurality of pre-position content representations to store in the content storage database prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and
store at least some of the pre-position content representations in the content storage database; and
the content storage database stores the at least some of the pre-position content representations so that the at least some of the pre-position content representations are available for playback by the at least one client device using the local network.

13. The apparatus of claim 12, wherein the content storage controller is further configured to, for each client device, determine the device playback characteristics by:
identifying at least one multimedia player available for multimedia playback on that client device;
for each multimedia player, determining at least one player-specific set of playback characteristics, each player-specific set of playback characteristics defining multimedia representation types playable using that multimedia player; and
determining the device playback characteristics for that client device to include the at least one player-specific set of playback characteristics for each multimedia player.

14. The apparatus of claim 12, wherein the content storage controller is further configured to store the at least some of the pre-position content representations in the content storage database by:
determining a prioritized list of pre-position content representations to store from the plurality of pre-position content representations; and
storing the at least some of the pre-position content representations from the plurality of pre-position content representations in priority order using the prioritized list of pre-position content representations,

15. The apparatus of claim 14, wherein the content storage controller is configured to determine the prioritized list of pre-position content representations by:
monitoring historic representation type data defining at least one multimedia representation type previously played back using the at least one client device;
determining preferred content representation types based on the monitored historic representation type data, each preferred content representation type corresponding to one of the location-specific multimedia representation types;
identifying preferred content representations as pre-position content representations in the plurality of pre-position content representations corresponding to one of the preferred content representation types; and
determining the prioritized list using the preferred content representations.

16. The apparatus of claim 14, wherein the content storage controller is further configured to:
identify a location-specific content threshold, the location-specific content threshold defining a minimum amount of content to be stored in the content storage database;
determine an available storage capacity in the content storage database;
determine a stored content level defining an amount of pre-position content representations currently stored in the content storage database; and
determine the prioritized list of pre-position content representations based on the location-specific content threshold, the stored content level and the available storage capacity.

17. The apparatus of claim 12, wherein the content storage controller is further configured to:
determine a pre-positioning window data policy data, the data policy data defining limits on downloads to the content caching system over the wide network; and
store the at least some of the pre-position content representations in the content storage database during the pre-positioning window,

18. The apparatus of claim 17, wherein the content storage controller is further configured to:
determine a window allowance for the pre-position window using historic bitrate data for the content caching system, the historic bitrate data defining a historically achieved download bitrate between the content caching system and the at least one content delivery server over the wide network; and
limit the storage of the at least some of the pre-position content representations during the pre-positioning window based on the determined window allowance.

19. The apparatus of claim 12, wherein the content storage controller is configured to determine the location-specific content indicators by:
monitoring historic content type data defining at least content type previously played using the at least one client device;
determining preferred content types from the monitored historic content type data; and
determining the location-specific content indicators using the preferred content types.

20. The apparatus of claim 12, wherein the content storage controller is further configured to;
identify a multimedia request from a particular client device of the at least one client device, the multimedia request defining a particular multimedia content instance to be played at the particular client device;
identify a particular pre-position content representation stored in the content storage database that, is a representation of the particular multimedia content instance requested; and
provide the particular pre-position content representation from the content storage database to the particular client device for playing the particular multimedia content instance.

21. The apparatus of claim 20 wherein:
the multimedia request identifies a requested multimedia representation type; and
the multimedia representation type corresponding to the particular pre-position content representation is different from the requested multimedia representation type.

22. The apparatus of claim 20 wherein:
the multimedia request defines a request for available multimedia representation types for the particular multimedia content instance; and
the content storage controller is configured to:
intercept an availability manifest being transmitted to the particular client device, the availability manifest identifying at least one initial available multimedia representation type;
modify the availability manifest by at least one of removing one of the initial available multimedia representation types and adding an additional available multimedia representation types; and
transmit the modified availability manifest to the particular client device.

23. A non-transitory, computer-readable storage medium storing instructions executable by a processor coupled to the storage medium, the instructions for programming the processor to:
communicate with at least one client device over a local network and to at least one content delivery server over a wide network:
determine device playback characteristics for each client device of the at least one client device, the device playback characteristics for a particular client device defining multimedia representation types playable using that particular client device;
determine a plurality of location-specific multimedia representation types for the at least one client device, each location-specific multimedia representation type suitable for playback on a particular client device of the at least one client device;
determine location-specific content indicators for the at least one client device;
identify a plurality of multimedia content instances from the location-specific content indicators;
identify a plurality of pre-position content representations to store in a content storage database prior to receiving a request for at least some of the pre-position content representations, the plurality of pre-position content representations identified based on the plurality of multimedia content instances and the plurality of location-specific multimedia representation types, each pre-position content representation corresponding to one of the multimedia content instances and to one of the multimedia representation types from the plurality of location-specific multimedia representation types; and
store at least some of the pre-position content representations in the content storage database so that the at least some of the pre-position content representations are available for playback by the at least one client device using the local network.
